(19) United States
(12) Patent Application Publication
(10) Pub. No.: US 2003/0222843 A1
(43) Pub. Date: Dec. 4, 2003

(54) Systems and methods for encoding control signals initiated from remote devices

(76) Inventor: Blair B.A. Birmingham, Toronto (CA)

Correspondence Address: TOLER & LARSON & ABEL L.L.P., PO BOX 29567, AUSTIN, TX, 78755-9567, US

(21) Appl. No.: 10/156,491

(22) Filed: May 28, 2002

(51) Int. Cl. G09G 5/00

(52) U.S. Cl. 345/156

(57) ABSTRACT

Systems and methods for encoding control signals initiated from remote devices are disclosed. In one form, a device for processing control signals initiated from a remote device includes a receiver module operable to receive at least one signal including a process request. A media processing module coupled to the receiver module encodes information associated with initiating the process request with media information representing a media signal. As such, a process request encoded with the media information may be detected via a media processor operably associated with processing media information.

### FIELD OF THE DISCLOSURE

The present invention generally relates to control signal processing and, more particularly, to system and method for encoding control signals initiated from remote devices.

### BACKGROUND OF THE INVENTION

Conventional remote controls may be used to control the functionality of electronic components or systems and may include a transmitter such as an RF or infrared transmitter configured to communicate signals to a complimentary receiver. Functionality of conventional remote controls include simple functions such as altering audible levels of a television or stereo component, fast forwarding through a movie, or changing channels or frequencies for broadcasts. Complex functionality in state-of-the-art electronic components may include changing view angles of digital media, authoring or selecting video segments to create home movies, checking email, or even launching a browser to surf the Internet.

As modular systems or components converge, integrating functions associated with enabling remote control of resulting systems or components require careful consideration. One problem that may occur in some conventional computer systems employing multimedia components includes latency observed between when a user requests a function using a remote device and the actual processing of the function. For example, a computer system may include a television frequency tuner that receives broadcasted television signals. The computer system may also include a remote control having several different functions for controlling the hardware and software associated with providing a personal computer television (PCTV). When a user selects a function via the remote control, a delay may be experienced causing a user to repeatedly select the function button. Such a problem may be caused due to a lack of system resources available to process the request in an efficient manner. For example, some conventional computer systems include process dependent variables such as the speed of the processor, available memory, bandwidth, etc. that effect the overall system performance and possibly contributing to an observable latency between a remote control process request and execution of a selected function.

For example, a signal representing the request may be received by a remote control receiver and an interrupt request is communicated to a graphics processor. The graphics processor services the request and communicates data to a system controller via a bus interface unit. Upon the data being received by the system level controller, and provided the system level has resources available to process the request, an interrupt or signal is transmitted to an associated hardware device or software application/interface operable to carry out the requested function. As such, latency associated with processing the request may leave a user with a sense of ‘slowness’ or ‘unresponsiveness’ due to the level of system processing required to process the requested function.

A current solution for reducing latency includes providing a dedicated microcontroller for detecting and handling remote control processing requests. The microcontroller requires a co-processor (such as a graphics processor) to periodically poll or process interrupts from the microcontroller to implement a request. Degraded performance of the co-processor may be experienced due to processing overhead required to process a request thereby reducing bandwidth availability and efficiency of the co-processor. For example, a graphics processor may periodically need additional bandwidth for graphic intensive computations. As such, processing overhead required by the microcontroller limits processing available during such periods of increased processing.

From the above discussion it should be apparent that conventional solutions fail to efficiently handle remote processing requests thereby degrading system performance of a system using remote control devices.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is a block diagram of receiver module operable to encode a process request in association with media information according to one embodiment of the invention;

FIG. 2 illustrates a method for encoding process requests according to one embodiment of the invention;

FIG. 3A illustrates a block diagram of a system interface module operable to encode processing requests initiated by a remote device according to one embodiment of the invention;

FIG. 3B illustrates a block diagram of a graphical user interface associated with a system interface module operable to encode processing requests using audio information according to one embodiment of the invention;

FIG. 4 is a flow diagram of a method for encoding process requests for use with a system interface module according to one embodiment of the invention; and

FIG. 5 illustrates a block diagram of a computer system employing remote control processing requests encoded in association with media information according to one embodiment of the invention.

### DETAILED DESCRIPTION OF THE FIGURES

Advantageous embodiments of the disclosure provide systems and methods for encoding control signals initiated from remote devices. In specific embodiments, the disclosure provides for efficient processing of remote control functions while minimizing loss in performance of associated systems or devices. In one form, a device for processing control signals initiated from a remote device includes a receiver module operable to receive at least one signal including a process request and a media processing module, such as a graphic processor, coupled to a media signal receiver and operable to process media information. The media processing module may be coupled to the receiver module and information representing a remote control process request may be encoded with the media information and communicated to an output device.

In a particularized form, a system operable to employ remote control processing of media information is disclosed. The system includes a module operable to process media information and an encoder/decoder communicatively coupled to a remote control receiver module such as a television tuner. The encoder/decoder processes media information received via the television tuner and upon receiving a request for processing from the remote control receiver, the encoder/decoder provides information representing a remote control process request in association with the media information. In this manner, the media information including the process request information may be communicated to a processor such as a graphics processor, module, system, software routine, application driver, etc. operable to detect the process request and initiate processing the selected function.

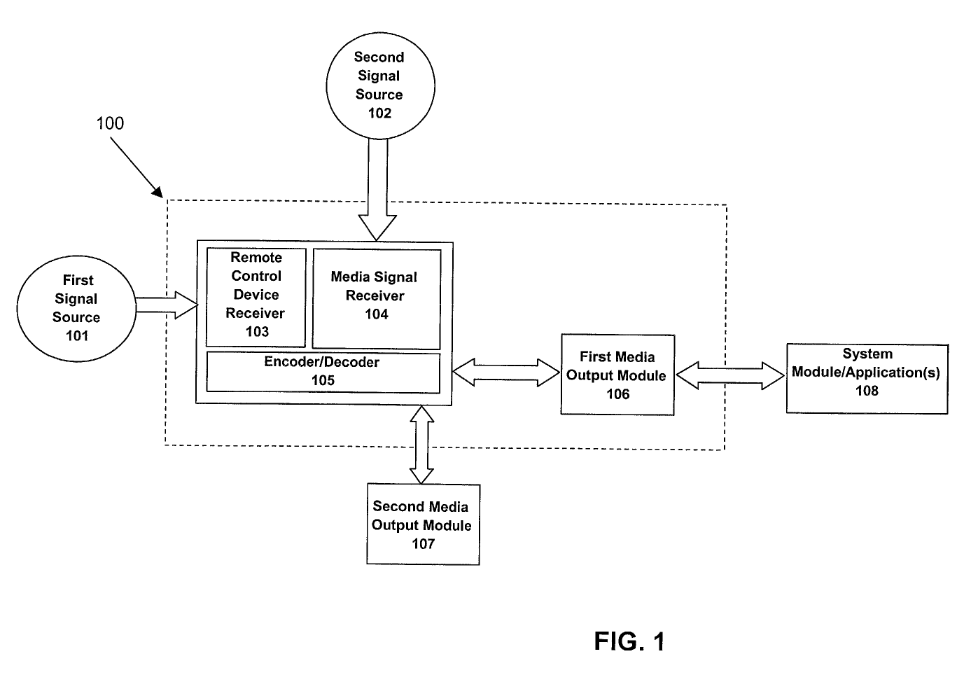

FIG. 1 is a block diagram of a receiver module 100 operable to encode a process request in association with media information according to one embodiment of the invention. Receiver module 100 includes a remote control device receiver 103 operable to receive remote signals initiated from a first signal source 101 such as a remote control transmitter. Module 100 further includes a media signal receiver 104 operable to receive multimedia signals communicated by one or more sources shown collectively at 102. An encoder/decoder 105 module processes signals received via media signal receiver 104 and/or remote control device receiver 103 and may be communicatively coupled to first and/or second media output modules 106 and 107. For example, first media output module 106 may be coupled to a system module and/or software application 108 operable to process and/or employ the remote control request.

During operation, media signal receiver 104 receives one or more media signals for use with a system such as a computer system or other systems operable to employ receiver module 100. For example, receiver module 100 may be used in association with a television, a cable set-top box, digital video recorder, digital satellite receiver, an add-on computer interface card, or other components, receivers, or modules operable to receive and/or process media signals. Receiver module 100 may also be integrated as a part of a media system or may be realized as a separate unit operable to process media information.

Receiver module 100 may be operable to process a television signal received via media signal receiver 104. Encoder/decoder 105 may be operable to decode a media signal into one or more components such as audio, video, local programming, etc. For example, receiver module 100 may receive a request from first signal source 101 to alter a characteristic associated with the media information such as altering an audio level associated with an audio portion of the media signal (i.e. increase, decrease, mute, etc.). As such, receiver module 100 may receive a process request and encode information associated with the request with the audio portion of the media information for transmission to an output module such as first media output module 106. Upon receiving the encoded process request, the output device such as first media output module 106 may detect the process request and initiate altering the audio level request and/or other characteristics that may be associated with processing one or more remote requests. By transmitting process request information with media data, efficient processing of remote control signal requests maybe employed using a low level of system overhead.

In one embodiment, encoder/decoder 105 may be used to encode information representing a remote control request in association with a media steam communicated to a graphics processor operably associated with first media output module 106. For example, first media output module 106 may be a graphics accelerator card operable to process graphic information using one or more processors. As such, media information having information related to a requested process may be communicated to a graphics processor operable to detect and initiate processing the requested function allowing for efficient execution of remote requests via a graphic processor.

In a similar manner, receiver module 100 may be used in association with processing multi-media signals having content rich media information. For example, a digital video recorder (DVR)(not expressly shown) may be coupled to receiver module 100 for processing digital video. Additionally, first signal source 101 may include a wireless remote control device such as a universal controller, keyboard, etc. for operating the DVR. As such, first signal source 101 may initiate a processing request and communicate a signal to receiver module 100. For example, a user may wish to change a view angle of video being played. The request may be received by remote control device receiver 103 and information associated with processing the request may be encoded within a portion or in association with media information provided by second signal source 102 and encoded/decoded by encoder/decoder 105. For example, the request may be encoded within video and/or audio portions of a signal received by media signal receiver 104.

In one embodiment, a representation of a control request from a remote control device can be included in a standard protocol format that is transmitted from the encoder/decoder 105 at a rate that is higher than normal. An implementation of one such protocol would double the rate at which the digital media data is transmitted. This would allow for control data to be embedded in every other piece of data being transmitted. For example, an audio bitstream normally transmitted as a series of LPCM (Linear Pulse Code Modulation) samples at 44,000 samples per second could be transmitted at 88,000 samples per second to allow control information to be included in alternate samples. In another embodiment, control information could be embedded in a MPEG (Motion Picture Expert Group) stream. For example, the control data could be associated with a unique packet identifier, or could be included in data associated with an existing packet identifier by using a predefined field or data identifier to indicate that control data is included within a particular packet having the packet identifier. In this manner, control information from a remote control device can be provided between a receiver module 100 and a system 108 in an efficient manner. Examples of specific types of remote control include controlling mouse movements, channel and volume up/down commands, and channel and volume change commands.

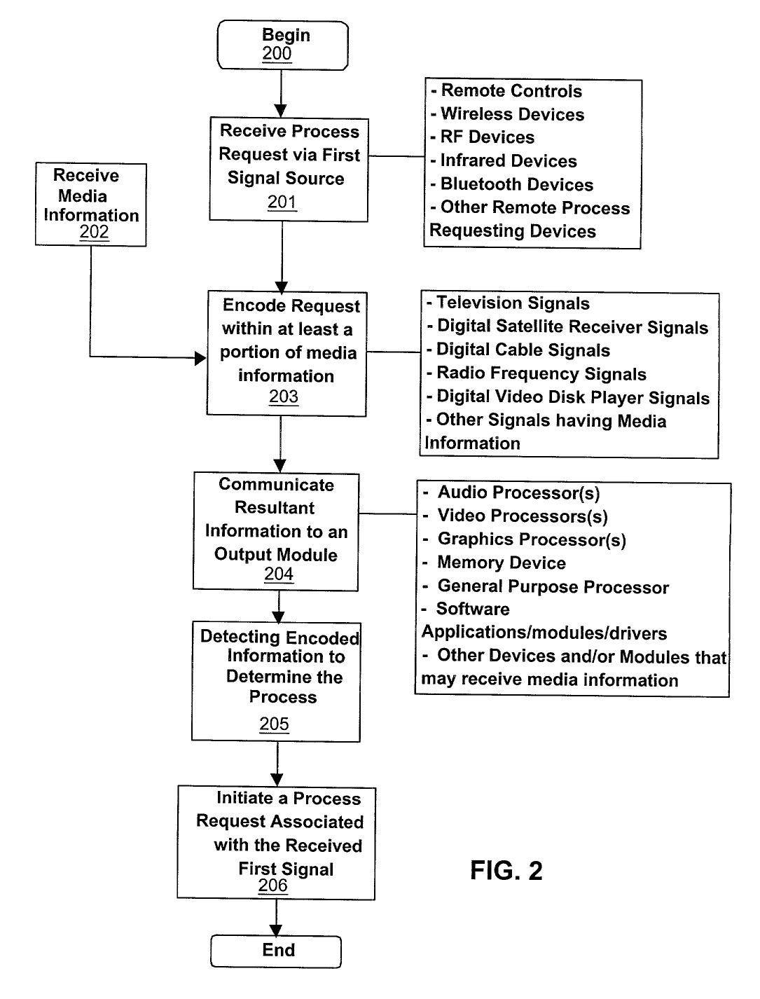

FIG. 2 illustrates a method for encoding process requests within media information according to one embodiment of the invention. The method may be employed within a program of instructions embodied within a computer readable medium, a memory device, encoded logic, or other devices or systems operable to use a portion or all of the method illustrated in FIG. 2.

The method begins generally at step 200. At step 201 a signal representing a processing request is received via a first signal source such as a remote control device operably associated with requesting control functions. Such remote devices may include wireless keyboards, remote controls, universal remote controls, Bluetooth (i.e. frequency band of 2.45 GHz) enabled devices, or other devices operable communicate signals for initiating remote control of media information.

Upon receiving a request, information associated with initiating a processing request is encoded with or in association with received media information at step 202. For example, the method may detect a process request and include information operable to identify the process request within a media stream such as a video and/or audio stream. Media information having encoded information representing a process request may then be communicated to an output module at step 203 that is operable to detect information for initiating a selected remote process. For example, an output module may include encoded logic operable to detect encoded control data and initiate a requested process at step 204. Such logic may be included as a part of a processor such as an audio processor, video processor, graphics processor, memory device, software application, device driver, application program interface and/or other devices, modules, or applications operable to detect a process request provided in association with media information.

Upon detecting the encoded information, the method proceeds to step 205 where the method initiates processing of the remote control function. For example, the request may be operably associated with a graphical user interface displayed within a monitor, flat panel display, or other components operable to display graphic information. The graphical user interface may include a control panel having several function buttons operably associated with controlling a tuner such as a television tuner for controlling one or more functions directly or indirectly associated with displaying media information within a portion of the display or outputting audio information via an audio output device. As such the graphic control panel may be operable to visually display information in response to a user selecting a function button on a remote control. For example, a request to alter an audio level of a television program may include altering the level of a graphic volume bar in addition to controlling an amplitude signal operably associated with increasing or decreasing volume. As such, media information including the requested remote control process may be received by a software application operable to display responses to a remote control process request and process the request using an appropriate hardware component. In this manner, a method for processing remote control processing requests may be employed with minimal processing overhead thereby reducing latency that may occur with processing remote control function requests.

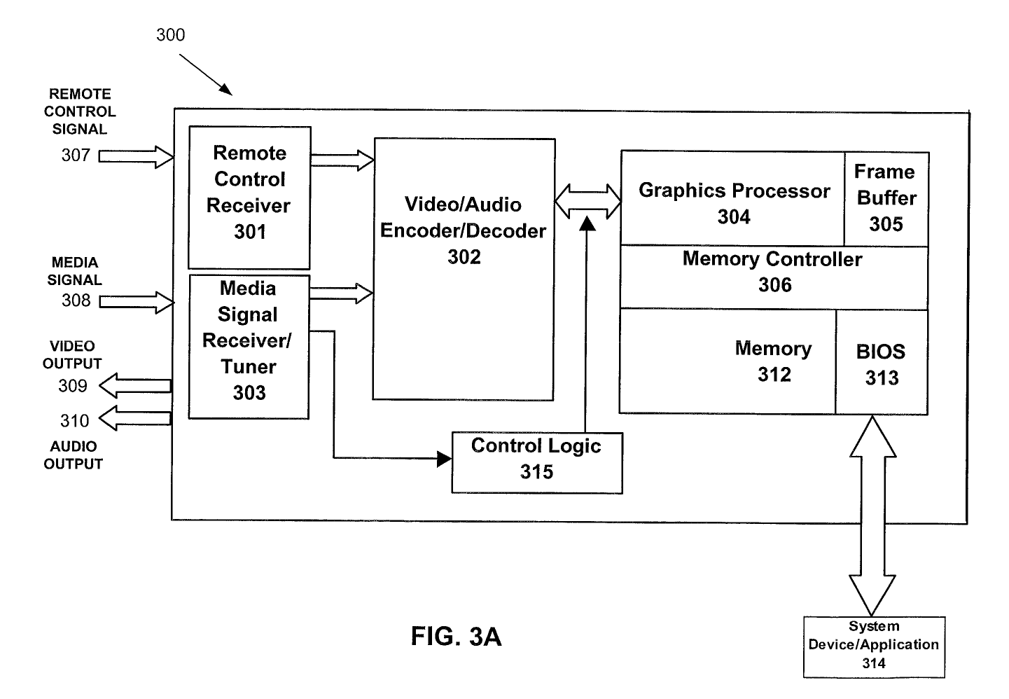

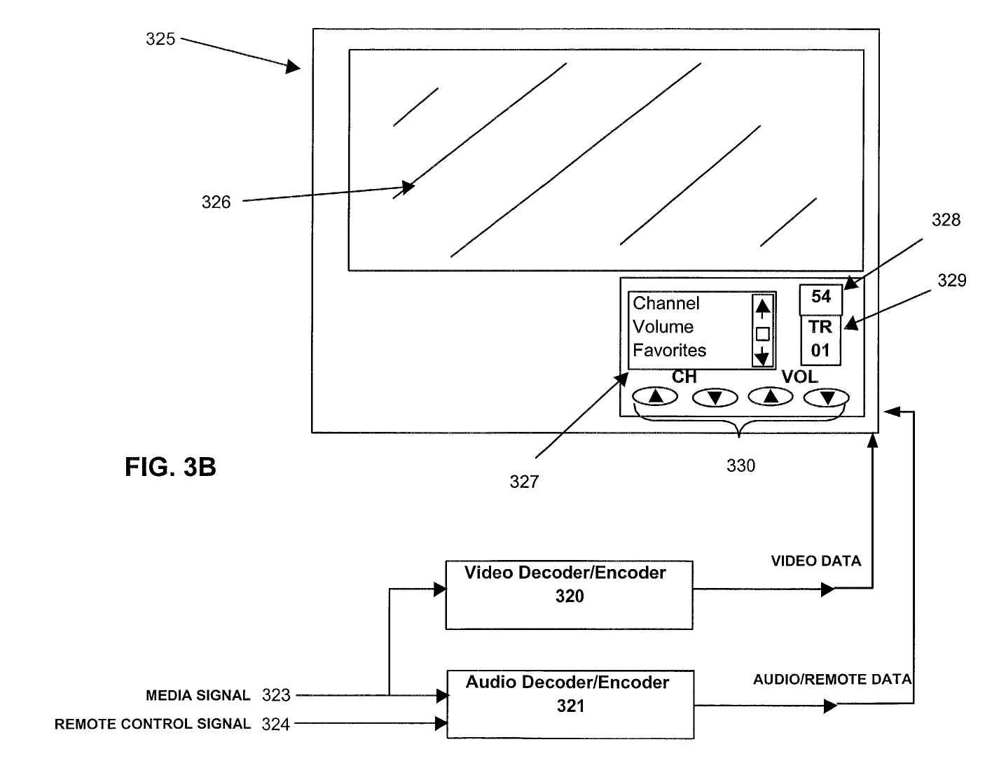

FIG. 3A illustrates a block diagram of a system interface module operable to encode processing requests initiated by a remote device according to one embodiment of the invention. A module, illustrated generally at 300, includes a remote control receiver 301 operable to receive remotely communicated signals via first input 307. Media information may be communicated to media signal receiver/tuner 303 via second input 308 and may include one or more types of media information. For example, media signal receiver/tuner 303 may be operable as a tuner for receiving media information broadcast over one or more frequencies. In one embodiment, media information may include a television broadcast, a cable television broadcast, digital satellite signals, or other signals or devices operable to input video and/or audio signals such as digital cameras, digital video recorders, digital audio players, etc.

Module 300 further includes a video/audio encoder/decoder 302 operable to encode and/or decode media information. Video/audio encoder/decoder 302 may translate encoded information into an original format (e.g., it decodes the data). In one embodiment, module 300 may be operable as an expansion board for a computer system (not expressly shown) and media signal receiver 303 may include a television tuner operable to select channels. Video/audio encoder/decoder 302 may convert (encode) the received signals from one standard to another, such as a TV video standard (NTSC) to a computer's video standard (such as VGA or SVGA). In this manner, a computer system may receive a television broadcast in addition to performing other computer-like functions. In another embodiment, the module 302 can re-encode the combined remote data and video data into a format similar to the format of the media signal 308.

For example, video/audio encoder/decoder 302 may receive a digital cable broadcast signal and encode/decode the broadcast signal into a format operable to be used with an output device via one or more output ports 309, 310, 311. For example, output port 311 may be coupled to a communications bus such as a PCI of a computer system (not expressly shown) operable to communicate video information to system device/software application 314 operable to receive media information in association with a process request. Video/audio encoder/decoder 302 may also output selective signals to a video output device 307 and/or provide media information having audio information to an output device or components such as a sound card via output port 310.

In another embodiment, video/audio encoder/decoder 302 may be used as a multi-standard video encoder/decoder operable to convert images of Windows, MAC OS, DVD movies games, etc. into all NTSC and PAL formats for TV viewing. The video/audio encoder/decoder 302 may use programmable timing to generate high quality TV signals from several different video sources providing graphics display modes that may range in resolution from 320×200 to 800×600.

In one embodiment, a remote control transmitter may transmit plural frequencies operably associated with specific functions to module 300. As such, module 300 may be operable to receive the plural frequencies and associate a requested function based on the received frequency. In this manner, one remote device operable to transmit one or more frequencies may be encoded in association with media information and processed accordingly.

Module 300 further includes control logic 315 operably associated with specific functions for controlling media information received by module 300. For example, control logic may include registers having encoded logic associated with controlling application program interfaces, software applications, drivers, etc. operably associated with using remote control signal requests.

Module 300 further includes a graphics processor 304 operably coupled to video/audio encoder/decoder 302 and includes associated electronic devices, memory processors, co-processors, etc. for processing graphical transformations. Graphics processor 304 is operably coupled to a memory controller 306, memory 312, and a frame buffer 305. During use, graphics processor 304 provides graphic computations and includes memory 312 reserved for storing graphical representations. For example, an amount of memory used determines how much resolution and how many colors can be displayed by a computer system. Memory 312 may include conventional DRAM however other types of memory may be employed by graphics processor 304 such as video RAM (VRAM) and/or windows RAM (WRAM) operable to be accessed by two different devices simultaneously allowing for a display to be updated at substantially the same time graphics processor 304 provides graphic data. Module 300 further includes BIOS 313 for assisting with communicating information between system device/application(s) 314 via bus 311.

Frame buffer 305 may be used in association with providing a media stream that may be communicated to an output device. Streaming media information is a technique for transferring media information such that it can be processed as a steady and continuous stream. As such, output devices may use portions of the media information without having an entire file representing the media information communicated to an output device or component.

During use, module 300 may receive an input from a remote control device via remote control receiver 301 and communicate a signal to video/audio encoder/decoder 302 to indicate that a remote control signal has been received. Video/audio encoder/decoder 302 may then encode the request within, or in association with, media information received by media signal receiver/tuner 303. For example, video/audio encoder/decoder 302 may include information relating to the requested process within a portion of a video stream and communicate the video stream to an output module. Upon an output module receiving the video stream, the output module may detect the encoded information and initiate processing the remote request. In this manner, encoded logic for handling remote control requests may be included as a part of information processed by video/audio encoder/decoder 302 allowing for integration of remote functionality within processed media information.

FIG. 3B is a block diagram of a graphical user interface associated with a system interface module operable to encode processing requests using audio information according to one embodiment of the invention. A media signal may be received via first input port 323 and divided into constituent components and communicated to video decoder/encoder 320 and audio decoder/encoder 321. A remote control signal may be received via second input port 324 and communicated to audio decoder/encoder 321. Audio decoder/encoder 321 may encode the remote control signal in association with the audio portion of the media signal and output the encoded information as audio/remote data to a device, module, software application, device driver, etc. operable to receive and process the remote control function requested.

In one embodiment, a graphical user interface 325 may be operable as a media player and may be operably associated with hardware, software, modules, drivers, logic, etc. for providing interactive graphical representations for controlling and displaying media information. Control window 329 includes a selectable list 327, a channel display 328, a track number display 329 and array of function buttons 330 for altering channels and volume levels. Control logic and software for processing remote control function requests are operably associated with graphical user interface 325 and may be used for controlling media played by the media player. For example, a user may want to alter a channel displayed within display 326 and channel display 328. As such, a remote control signal request for altering the channel may be received via second port 324 and encoded using audio decoder/encoder 321. The encoded information may then be communicated to an application operably associated with controlling hardware associated with the request and software responsible for altering the state of the displayed channel number and video data. In this manner, remote control requests for functions displayed within a media player may be encoded with media information and processed using an component or application operable to employ the requested remote control function.

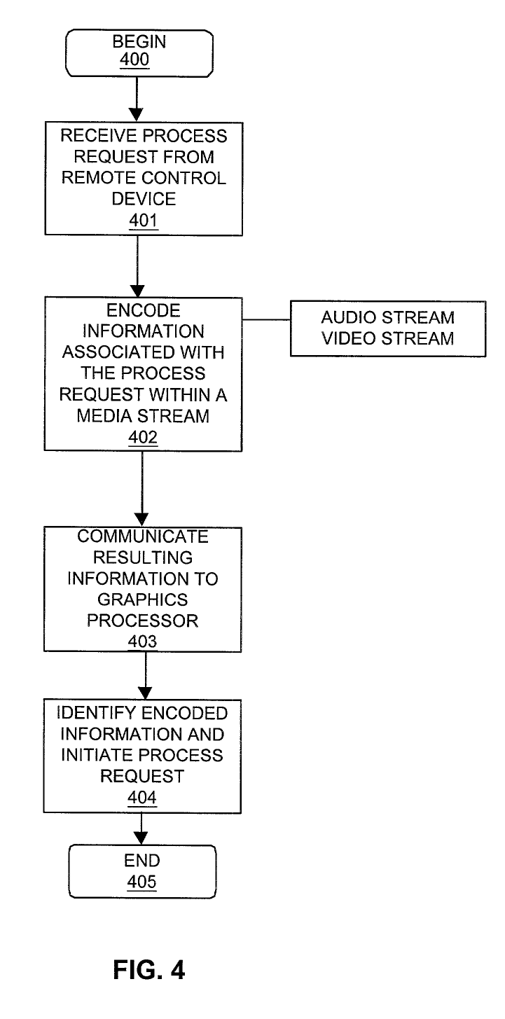

FIG. 4 is a flow diagram of a method for encoding process requests for use with a system interface module according to one embodiment of the invention. The method may be employed within a program of instructions embodied within a computer readable medium, a memory device, encoded logic, or other devices or systems operable to use a portion or all of the method illustrated in FIG. 4.

The method begins generally at step 400. At step 401 a process request from a remote control device is received by a remote control receiver and detected by an encoder/decoder operable to encode and/or decode media information. Upon receiving the input signal, the method proceeds to encode the requested process 402 within a portion of media information received from a media source. For example, a media source may include a TV tuner operably coupled to the encoder/decoder for receiving television broadcasts. The encoder/decoder translate the TV signal and includes information associated with the requested process in association with a video portion and audio portions of the broadcast signal communicating the audio portion of the media information to a system level device or component.

Upon encoding the request the method proceeds to step 403 where the method communicates the media information including information associated with the request to a graphics processor operable to receive the graphic information or a system level component operable to receive the audio portion of the media information. The method then proceeds to step 404 where the method identifies the encoded information using the graphics processor and/or system level device initiates the requested remote control function. The method then proceeds to step 405 where the method ends.

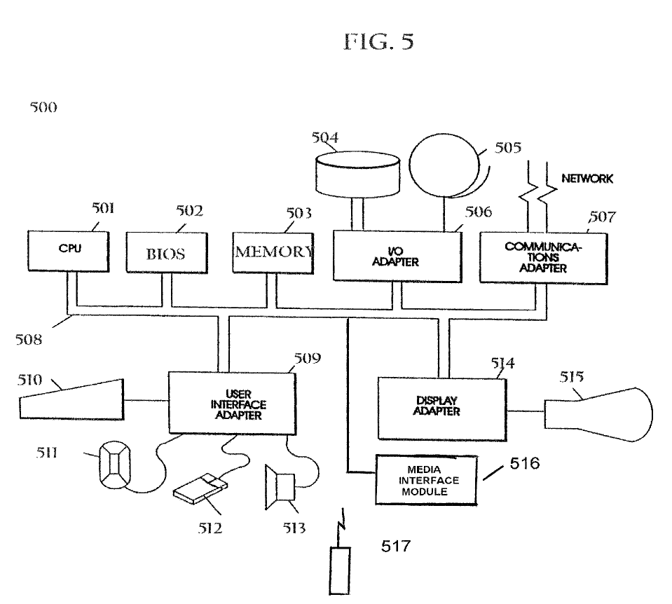

FIG. 5 illustrates a block diagram of a computer system employing remote control processing requests encoded in association with media information according to one embodiment of the invention. A system, indicated generally at 500, includes a central processing unit (CPU) 501 connected via at least one bus 508 to a basic input output system (BIOS) firmware 502, and memory, such as RAM, ROM, EEPROM, and any other memory devices, collectively designated by reference numeral 503. System 500 further includes an input/output adapter 506 for connecting peripheral devices such as SCSI drives 504 and RAID drives 505, and a display adapter 514 for connecting a display device 515 such as a Flat Panel Display (FPD) or a Cathode Ray Tube (CRT). A user interface adapter 509 is provided for connecting a keyboard 510, a mouse 512, a speaker 513, a microphone 511, and/or other user interface devices such as game controllers, touch pads, etc. System 500 also includes a communications adapter 507 for connecting system 500 to an information network such as an Intranet or the Internet.

BIOS firmware 502 includes a built-in software program, referenced generally as BIOS, accessible to system 500. The BIOS includes instructions for controlling the system's devices and testing memory. During operation, when system 500 is initially powered up, CPU 501 activates the BIOS. The BIOS runs a series of tests using a power on self test (POST) routine that initializes the system's hardware, chip registers, disk drives, power management, I/O ports and any other device requiring initialization by a POST routine.

System 500 may also include media interface module 516 operable as a television tuner for receiving broadcast television signals an translating the signals into usable format for system 500. A remote control 517 may be used with system 500 for initiating remote control functions. Additionally, system 500 includes a complimentary remote control receiver that may be integrated as a part of media interface module 516, user interface adapter 509, provided as a separate unit (not expressly shown), or integrated as a part of other components or devices coupled to system 500.

During use, a user may select a function key associated with the remote control 517 and system 500 may receive a signal associated with the selected function via a complimentary remote control receiver. The signal may be provided to media interface module 516 indicating that a remote control function has been selected and information associated with identifying the remote selected function may be encoded and included within or in association with a video and/or audio portion of a translated signal. For example, media interface module 516 may include an audio/video encoder/decoder (not expressly shown) operable to receive media signals from several different sources and translate the media signals into a format that may be used by system 500. In one embodiment, media interface module 516 including a television tuner may translate a television broadcast signal into audio and video portions using an audio/video encoder/decoder. As such, a remote control request may be encoded within, or provided in association with, the translated audio or video and communicated to an output device, module, component, etc. operable to receive the translated media information. For example, a video portion of the television signal may be communicated to a graphics processor (not expressly shown) operable to process graphic information. Additionally, the graphics processor may be configured to process remote control functions for system 500. As such, the graphics processor may detect the requested process and initiate processing of the requested function. In this manner, additional hardware and/or system resources are not needed for detecting and initiating processing of remote control functions.

Although the disclosed embodiments have been described in detail, it should be understood that various changes, substitutions and alterations could be made to the embodiments without departing from their spirit and scope. For example, the decoder/encoder illustrated herein can represent an encoder only, or a decoder only module as appropriate for a specific implementation.

What is claimed is:

1. A device for processing control signals initiated from a remote device comprising:
a receiver module operable to receive at least one signal from a remote device including a process request;
a media signal receiver operable to receive signals representing media information; and
a media processing module coupled to the receiver module and the media signal receiver, the media processing module operable to encode process information in association with the media information.

2. The device of claim 1 further comprising a decoder operable to translate the media signal into one or more media information streams.

3. The device of claim 1 further comprising the media processing module operable to translate plural media signals into one or more media information streams.

4. The device of claim 1 further comprising the media processing module operable to receive a signal in response to the process request.

5. The device of claim 4 further comprising the media processing module operable to identify the requested process and provide the encoded information with the media information.

6. The device of claim 5 further comprising the media processing module operable to provide an audio stream.

7. The device of claim 5 further comprising the media processing module operable to provide a video stream.

8. The device of claim 1 further comprising a graphics processor operable to detect the encoded information, the graphics processor operable to initiate processing the request.

9. The device of claim 8 further comprising the graphics processor operable to communicate information associated with processing the request to a system module operable to process the request.

10. The device of claim 9 wherein the system module comprises software.

11. The device of claim 9 wherein the system module comprises a processor.

12. The device of claim 1 wherein the media signal receiver comprises a multimedia tuner.

13. The device of claim 1 wherein the media signal receiver comprises a audio frequency tuner.

14. The device of claim 1 wherein the media processing module comprises an multimedia device.

15. A method comprising:
receiving a process request via a remote signal source;
encoding information associated with the process request within media information translated from a received media signal; and
detecting the encoded information to initiate processing the requested process.

16. The method of claim 15 further comprising providing a signal identifying the received request to a media processing module.

17. The method of claim 15 further comprising:
decoding the received media signal to provide the media information representing at least a portion of the media signal; and
encoding information associated with the determined process within the media information.

18. The method of claim 17 further comprising providing video information within the media stream.

19. The method of claim 17 further comprising providing audio information within the media stream.

20. The method of claim 15 further comprising communicating the media information including the encoded information to a processor operable to detect the encoded information.

21. The method of claim 20 further comprising receiving the media information including the encoded information via a processor.

22. The method of claim 21 further comprising initiating processing of the requested process using a graphics processor.

23. The method of claim 22 further comprising initiating processing the requested process based on the encoded information.

24. The method of claim 15 further comprising determining and identifier based on the received request, the identifier associated with identifying the requested process.

25. The method of claim 24 further comprising receiving a signal of a particular frequency operably associated with identifying the requested process.

26. A system operable to employ remote control processing of media information comprising:
a media interface module coupled to a communication bus, the media interface module operable to process media information; and
a media processing module communicatively coupled to a remote control receiver module, the media processing module operable to encode information in response to receiving a remote control process request.

27. The system of claim 26 further comprising the media processing module operable to provide media information associated with a media signal, the media information including information associated with processing the remote control process request.

28. The system of claim 27 wherein the media information comprises audio information.

29. The system of claim 27 wherein the media information comprises the video information.

30. The system of claim 26 further comprising:
an output module operable to receive media information including the encoded information; and
an encoder/decoder operable to provide the encoded information.

31. The system of claim 30 wherein the output module comprises a graphics processor operable to initiate the requested process.

32. The system of claim 31 further comprising a media signal receiver operably coupled to the media processing module, the media receiver operable to receive media signals.

33. The system of claim 31 wherein the receiver comprises a television receiver.

34. The system of claim 31 wherein the receiver comprises a cable receiver.

35. The system of claim 31 wherein the receiver comprises a digital satellite receiver.

36. The system of claim 26 further comprising a computer system.

37. The system of claim 26 further comprising a digital video recorder.

38. The system of claim 26 further comprising a digital video disk player.

39. The system of claim 26 further comprising a set-top box.

40. A system for processing remote control process requests comprising:
means for receiving a process request via a remote signal source;
means for encoding information associated with the process request within media information translated from a received media signal; and
means for detecting the encoded information to initiate processing the requested process.

41. A program of instructions embodied within encoded logic operable to:
receive a process request via a remote signal source;
encode information associated with the process request within media information translated from a received media signal; and
detect the encoded information to initiate processing the requested process.
